(19) United States
(12) Patent Application Publication
(10) Pub. No.: US 2003/0097410 A1
(43) Pub. Date: May 22, 2003

(54) Methodology for enabling multi-party collaboration across a data network

(76) Inventors: R. Travis Atkins, Santa Cruz, CA (US); Alan M. Vale, Mountain View, CA (US); Jon A. Howell, Scotts Valley, CA (US); James W. Spiers, Santa Cruz, CA (US); Adam G. Freeman, Santa, CA (US)

Correspondence Address: JOHN A. SMART, 708 BLOSSOM HILL RD., #201, LOS GATOS, CA, 95032, US

(21) Appl. No.: 09/972,652

(22) Filed: Oct. 4, 2001

(51) Int. Cl. G06F 15/16

(52) U.S. Cl. 709/206; 709/204

(57) ABSTRACT

A multi-party online collaboration system that optimizes both the participation of the collaborators and the universality of membership is described. The system satisfies the two requirements for networked collaboration by providing shareable objects and a means of notifying the collaborators whenever the state of the shared objects has changed. For an open network (i.e., the Internet), the preferred embodiment uses two open standards mechanisms: URL-addressable networks for the accessible shareable objects, and asynchronous messaging for notification of changes to the objects that do not occur in real-time. The preferred embodiment employs these two open standards systems to ensure universal access, and obviates the need for the collaborators to install/maintain proprietary client systems. The preferred embodiment monitors the state of the objects, and automatically dispatches notification messages, along with addresses (e.g., URLs) to those URL-addressable objects, to only those collaborators who responded to the previous notification. Because the system automatically handles the asynchronous messaging notifications and because these messages are dispatched only to those participants who are actively keeping current with the latest changes, the preferred embodiment precludes the generally chatty nature of asynchronous messaging systems. Whenever a collaborator does decide to use a notification link to visit the URL-addressable network site, he or she is further presented with a message describing an interface to all of the shared objects.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates to information processing and, more particularly, to collaborative information processing over a network, such as the Internet.

2. Description of the Background Art

Often it is desirable for two or more geographically separate persons to jointly work on a document or object. In order to asynchronously collaborate across a data network, users currently must interact with both asynchronous messaging networks and URL-based document networks in a manner that simulates a standard two-way “chat”, or an N-way messaging system. The popularity of URL-addressable networks as a platform for multi-party communication and collaboration services spurs the need for a mechanism facilitating this collaborative process. However, present-day collaborative environments fail to provide a platform-neutral, two-way-messaging enabled mechanism for collaboration over a network.

Of particular interest are those environments having an asynchronous messaging network combined with an URL-based document network. Specific examples of asynchronous messaging networks include: SMTP, polled POP3, SMS, WAP-push, or any of the broad-based instant messaging systems (e.g., AOL Instant Messenger, Yahoo Messenger, MSN Messenger, or the like). Specific examples of a URL-based network include HTTP and other high-level delivery protocols, such as FTP or IMAP, many peer-to-peer protocols (like Napster or Freenet), or a WSP (WAP) network, which may be used as a sub-network or mirroring network of the URL-addressable network.

Current asynchronous messaging systems have the ability to address messages to multiple individuals, but the “body” of those messages (e.g., documents, attachments or other objects) must be sent along with the messages themselves. In common e-mail systems, such as SMTP (e.g., as described in RFC 821), the body of a message contains either text and/or MIME attachments. Transmission of these documents, objects and other attachments to multiple individuals is also resource intensive and typically results in the creation of multiple copies of the documents or objects.

It is more efficient and more manageable for a user to be able to send a simple hyper-link (e.g., a URL reference address) for the documents or objects referenced in the message, so that when the message is received, the recipient can follow that link to the object which the link references. However, it is desirable that such a system would enable the recipient/collaborator to experience the interaction (look-and-feel) of a simple two-way messaging system when following such a link and working with the document or object of interest.

Existing groupware solutions permit two or more individuals to jointly work on a shared document. For example, Microsoft has implemented a collaboration server, Microsoft Exchange Server, which manages versioning for shared network documents, wherein the collaborators communicate via e-mail. Lotus Notes is another example that integrates URL-based documents and asynchronous messaging. However, users of Microsoft Exchange Server or Lotus Notes must install proprietary client software on the user's local system. These groupware solutions (Microsoft Outlook and Lotus Notes, respectively) do not allow the user to utilize this collaboration environment with client devices that employ differing standards, whether proprietary or open.

The simplest approach for document sharing using existing systems would be for users to store everything in a URL-based document network (e.g., the Internet). To share, users simply e-mail links to stored documents. This is the seemingly simplest procedure, wherein users may store any type of files, and then interact with, and operate on, the stored repository of files.

For example, a photo-sharing URL-addressable network site may serve as a repository for users' digital image files. Users can organize their photos into separate containers (such as online photo albums), move photos from album to album, and/or “share” these photo collections over the Internet. An owner of an online album may send e-mail to a list of recipients; the e-mail message includes a URL link to the owner's album at the photo-sharing URL-addressable network site. Recipients following the link to the photo-sharing site may leave comments about the photos for the owner and other recipients to read. The “collaborative interaction” is the progressive exchange of online comments about the album(s) or photos.

However, such a system does not enable true collaborative workflow, that is, interactive processes that add new information to shared documents and propagate change notifications to all collaborators. For example, in the current system described above, users are not notified when others return to the site and add new comments. Also, there is no obvious way for participants to continue a collaborative process of reviewing and modifying the shared documents or objects.

Moreover, collaboration systems of the prior art rely on proprietary software that has several shortcomings:

1. There is no enforced interaction model to ensure that change notifications are always dispatched, and that these changes are either referring to the same document(s) or even to the same versions of the document(s).

2. Current systems that enable continuous collaboration require manual management and tracking by participating users, and do not automatically notify users of updates.

3. Current proprietary solutions are not extensible to an entire class of devices, such as cellular phones or other devices which have the ability to browse the URL-addressable network (access URL-based documents) and send/receive e-mail, but do not support any other the proprietary client software that is required to utilize such proprietary solutions. Furthermore, the embedded software in such devices typically cannot be upgraded to support proprietary client software. Thus, current proprietary solutions are not extensible to such systems/devices.

4. Existing peer-to-peer communication systems (i.e., asynchronous messaging) are proprietary. For example, Groove, a peer-to-peer Lotus Notes-like client (which may be thought of as a de-centralized version of Lotus Notes) is proprietary. Groove's collaborative notes do not allow for simple un-encrypted e-mail messaging.

5. None of these proprietary solutions can work on client devices that only support open standards for browsing the URL-addressable networks and e-mailing. Such pre-configured machines cannot easily utilize newer protocols, whether proprietary or open. Proprietary systems do not provide any formalized workflow interaction common to various users using various clients/systems.

Because of the ever-increasing popularity of both e-mail and the Web, much interest exists in providing a platform-neutral, two-way messaging enabled network collaboration system that addresses these problems.

### Glossary

Apache Plug-ins: Loadable executable modules for the Apache Web server. More information is available at the following URL: http://httpd.apache.org/docs/misc/API.html.

BLOB: Acronym for binary large object, which is a collection of binary data stored as a single entity in database management systems (DBMS). BLOBs are used primarily to hold multimedia objects such as images, videos, and sound, though they can also be used to store programs or even fragments of code. Not all DBMSs support BLOBs.

CGI: Acronym for Common Gateway Interface. The CGI is a specification for transferring information between a World Wide Web server and a CGI program. The CGI specification is available from the University of Illinois, Urbana-Champaign (see e.g., http://hoohoo.ncsa.uiuc.edu/cgi/). A CGI program is any program designed to accept and return data that conforms to the CGI specification. The program could be written in any programming language, including C, Perl, Java, or Visual Basic. CGI programs are the most common way for URL-addressable network servers to interact dynamically with users. Many HTML pages that contain forms, for example, use a CGI program to process the form's data once it is submitted. Another increasingly common way to provide dynamic feedback for URL-addressable network users is to include scripts or programs that run on the user's machine rather than the URL-addressable network server. These programs can be Java applets, Java scripts, or ActiveX controls. These technologies are known collectively as client-side solutions, while the use of CGI is a server-side solution because the processing occurs on the URL-addressable network server. One problem with CGI is that each time a CGI script is executed a new process is started. For busy URL-addressable network sites, this can slow down the server noticeably. A more efficient solution, but one that it is also more difficult to implement, is to use the server's API, such as ISAPI or NSAPI. Another increasingly popular solution is to use Java servlets.

FTP: Acronym for File Transfer Protocol, the protocol used on the Internet for sending files among connected devices.

GSM: Acronym for Global System for Mobile Communications, one of the leading digital cellular communications systems. GSM uses narrowband TDMA, which allows eight simultaneous calls on the same radio frequency.

HTTP: Acronym for “Hyper Text Transfer Protocol,” the underlying communication protocol used by the World Wide Web on the Internet. HTTP defines how messages are formatted and transmitted, and what actions URL-addressable network site servers and browsers should take in response to various commands. For example, when a user enters a URL in his or her browser, this actually sends an HTTP command to the URL-addressable network site server directing it to fetch and transmit the requested URL-addressable network page. Further description of HTTP is available in RFC 2616: Hypertext Transfer Protocol—IITTP/1.1, the disclosure of which is hereby incorporated by reference. RFC 2616 is available from the World Wide Consortium 25 (W3C), and is currently available via the Internet at the following URL: http://www.w3.org/Protocols/.

IMAP4: Acronym for the Internet Message Access Protocol, which is a protocol for retrieving e-mail messages. The latest version, IMAP4, is similar to POP3 but supports additional features. For example, with IMAP4, the client can search through his or her e-mail messages for keywords while the messages are still on a mail server. The client can then choose which messages to download to his or her local machine. Like POP, IMAP uses SMTP for communication between the e-mail client and the server.

POP3: Acronym for the Post Office Protocol, which is a protocol used to retrieve e-mail from a mail server. Most e-mail applications (also known as e-mail clients) use the POP protocol, although some can use the newer IMAP (Internet Message Access Protocol). There are two versions of POP: the first, called POP2, became a standard in the mid-1980's and requires SMTP to send messages. The newer version, POP3, can be used with or without SMTP.

SMS: Acronym for Short Message Service, used worldwide over the “Global System for Mobile Communications” (GSM) cellular phone system. Similar to paging, SMS is a service for sending short text messages to mobile phones. More information is available from the following URL: http://www.gsmworld.com/technology/sms.html.

SMTP: Acronym for Simple Mail Transfer Protocol, a protocol for sending e-mail messages between servers. Most e-mail systems that send mail over the Internet use SMTP to send messages from one server to another; the messages can then be retrieved with an e-mail client using either the POP or IMAP protocol. In addition, SMTP is generally used to send messages from a mail client to a mail server. This is why the clients specify both the POP or IMAP server and the SMTP server when configuring their e-mail application.

TDMA: Acronym for Time Division Multiple Access, a technology for delivering digital wireless service using time-division multiplexing. TDMA works by dividing a radio frequency into time slots and then allocating slots to multiple calls. In this way, a single frequency can support multiple, simultaneous data channels. TDMA is used by the GSM digital cellular system.

URL: Acronym for Uniform Resource Locator, which is the global address of documents and other resources on the World Wide Web. The first part of the address indicates what protocol to use, and the second part specifies the IP address or the domain name where the resource is located.

WAP: Acronym for the Wireless Application Protocol, which is a secure specification that allows users to access information instantly via handheld wireless devices such as mobile phones, pagers, two-way radios, smart-phones and communicators. WAP supports most wireless networks, which include CDPD, CDMA, GSM, PDC, PHS, TDMA, FLEX, ReFLEX, iDEN, TETRA, DECT, DataTAC, and Mobitex. WAP is supported by all operating systems; the following operating systems are specifically engineered for handheld devices: PalmOS, EPOC, Windows CE, FLEXOS, OS/9, and JavaOS. WAP-enabled systems that use displays and access the Internet run what are called micro-browsers. Micro-browsers are browsers with small file sizes that can accommodate the low memory constraints of handheld devices and the low-bandwidth constraints of a wireless-handheld network.

WAP-push: The asynchronous message delivery side of the wireless application protocol. A description of WAP-push is available from the Wireless Application Protocol Forum Ltd. (see, e.g., http://www.wapforum.org).

### SUMMARY OF THE INVENTION

A system is described that provides an online service for facilitating collaboration among several individuals across a data network, particularly the Internet. Two requirements for effective networked multi-party collaboration are shared dynamic documents or other objects of interest (hereinafter referred to collectively as “objects”), whose current state is also shared, and a communications modality wherein the collaborators are informed whenever there are updates or additions to the shared collection of objects. Ideally, each collaborator is able to modulate whether or not to be kept abreast of updates to any of the shared objects, and, therefore, can elect to engage or disengage from the continuum of the group collaboration. Also, the active collaborators should ideally be engaged only in affecting the shared objects, and not be responsible for notifying the other collaborators that he or she has posted a modification to those shared objects.

The present invention satisfies both the requirements for effective networked collaboration by employing two open standards communications channels to facilitate group participation: a URL-addressable network and an asynchronous messaging network. The present invention includes a URL-addressable network service site that facilitates communications among any number of networked (client) users, or collaborators. Objects are uploaded to the network service site by the clients using a bi-directional request-response protocol(s) (e.g., HTTP, WAP-push, or FTP), where those objects are stored in a local repository and made accessible to the collaborators via a link (e.g., URL address).

One collaborator (i.e., the “sharing client”) has either permission or an account at the site to initiate the collaboration, and uploads shareable objects along with a list of the network addresses of the other collaborators. When the sharing client requests a new collaboration, the network service site returns an instructional (text) message describing the sharing interface enabling the sharing client to upload the objects as well as to supply a list of the network addresses of the other collaborators. The message describing the sharing interface is typically an HTML or XML message describing the process for the sharing client to easily input/upload the objects and the list of the other collaborators' addresses. The network service site stores the objects and the list of collaborators' addresses in a local repository, and generates corresponding link(s) (e.g., URL addresses) for those shareable objects. To activate the collaboration, the network service site dispatches messages, via various asynchronous messaging networks, to all of the collaborating clients, including the sharing client. These asynchronous messages include URL link(s) for each of the objects.

Subsequently, whenever any interested collaborating client wishes to read, view, update, add to, or comment about the shared collection of objects, he or she uses those links to retrieve/download an instructional (text) message describing the collaborating interface for modifying or commenting on the objects. The message describing the collaborating interface is typically an HTML or XML message, which describes for the collaborators the process to use to upload to the network service site via the synchronous request-response network protocol.

The network service site tracks changes or comments (collectively “updates”) made to (or regarding) the shared collection of objects, and dispatches update notifications to the other collaborators via the asynchronous messaging channel. Subsequent updates to any of the objects trigger further dispatches of update notification; however, notification is not always sent to every collaborator. An application service engine at the network service site maintains records of when each collaborator has responded to the previous notification, and only dispatches a new notification of a new update to any of the objects to those collaborators who did, in fact, respond to the previous notification. A collaborator responds to these notifications by using the link(s) (e.g., URL) accompanying each notification to download both an instructional (text) message and a collaborating interface from the network service site. Accordingly, collaborators are not swamped with incoming notifications for each and every update that is made to the shared objects.

The preferred embodiment of the present invention provides a photo-sharing URL-addressable network site including a repository for users' digital image files. Sharing clients can organize their photos into separate containers (such as online photo albums), move photos from album to album, and/or share these photo collections over the network. Other collaborators respond by going on-line to the photo-sharing URL-addressable network site and leaving comments about the photos for the sharing client and other collaborators. The “collaborative interaction” is the progressive exchange of online comments about the album(s) or digital photo(s). This photo-sharing site includes a two-way messaging system, or a system behaving like a two-way messaging system. Any collaborator may use a link (e.g., URL) accompanying one of the incoming notification messages to navigate to an online album, view both the photo(s) of interest and prior comments posted about the shared photo(s), and post a new comment about the photos. In this manner, the user can easily collaborate in the online sharing of commentary about objects of common interest.

### BRIEF DESCRIPTION OF THE DRAWINGS

FIG. 1 is a block diagram of a computer system in which software-implemented processes of the present invention may be embodied.

FIG. 2 is a block diagram of a software system for controlling the operation of the computer system of FIG. 1.

FIG. 3 is a block diagram illustrating the overall architecture of the network collaboration system of the present invention.

FIG. 4 is a diagram of the components of a URL-addressable network service site.

FIGS. 5A and 5B are a two-page flowchart showing the sequence of the major operations for the present invention.

### DETAILED DESCRIPTION OF A PREFERRED EMBODIMENT

The following description will focus on the presently-preferred embodiment of the present invention, which is implemented in a desktop application operating in an Internet-connected environment running under a desktop operating system, such as Microsoft® Windows running on an IBM-compatible PC. The present invention, however, is not limited to any one particular application or any particular environment. Instead, those skilled in the art will find that the system and methods of the present invention may be advantageously embodied on a variety of different platforms, including Macintosh, Linux, BeOS, Solaris, UNIX, NextStep, FreeBDS, and the like. Therefore, the description of the exemplary embodiments that follows is for purposes of illustration and not limitation.

I. Computer-based Implementation

A. Basic System Hardware (e.g., for Desktop and Server Computers)

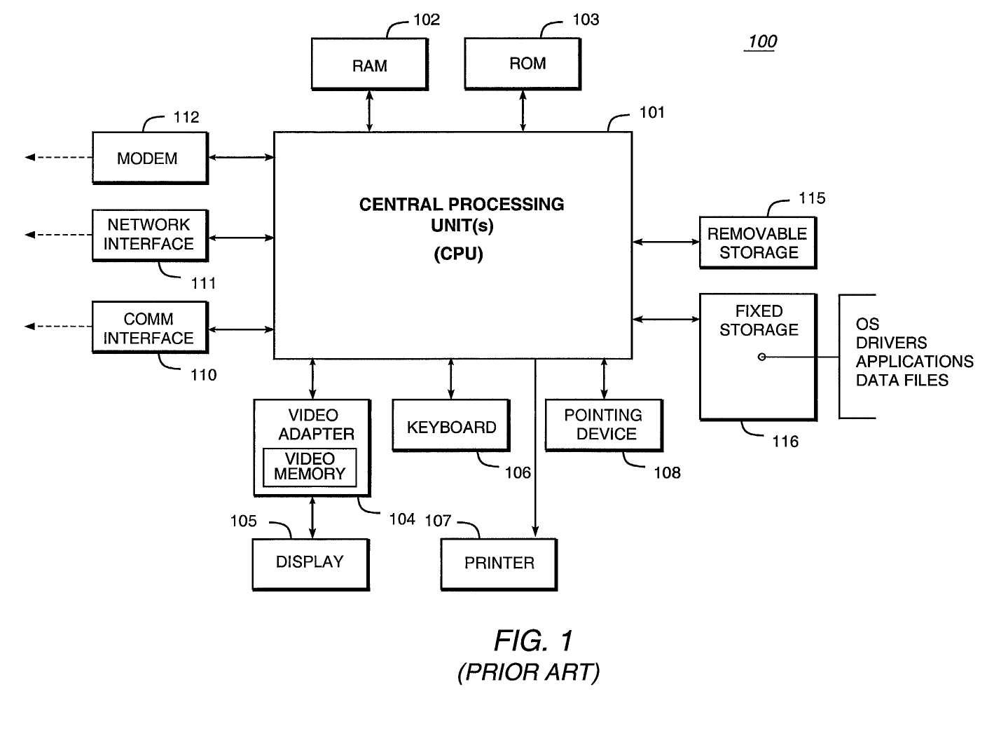

The present invention may be implemented on a conventional or general-purpose computer system, such as an IBM-compatible personal computer (PC) or server computer. FIG. 1 is a very general block diagram of an IBM-compatible system 100. As shown, system 100 comprises a central processing unit(s) (CPU) or processor(s) 101 coupled to a random access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, or the like), a fixed (mass) storage device 116 (e.g., hard disk), a communication port(s) or interface(s) 110, a modem 112, and a network interface card (NIC) or controller 111 (e.g., Ethernet). Although not shown separately, a real-time system clock is included with the system 100, in a conventional manner.

CPU 101 comprises a processor of the Intel Pentium® family of microprocessors. However, any other suitable microprocessor or microcomputer may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random access memory 102 serves as the working memory for the CPU 101. In a typical configuration, RAM of sixteen megabytes or more is employed. More or less memory may be used without departing from the scope of the present invention. The read-only memory (ROM) 103 contains the basic input output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements the methodology of the present invention described below) is loaded from the storage device or mass storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the display screen 105. Likewise, the pointing device 108, such as a mouse, track ball, pen device, or the like, permits selection and manipulation of objects on the display screen. In this manner, these input devices support manual user input for any process running on the system.

The computer system 100 displays text and/or graphic images and other data on the display device 105. The video adapter 104, which is interposed between the display device 105 and the system 100, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (“comm”) interface 110, which may include an RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Compaq Computers of Houston, Tex., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

B. Basic System Software

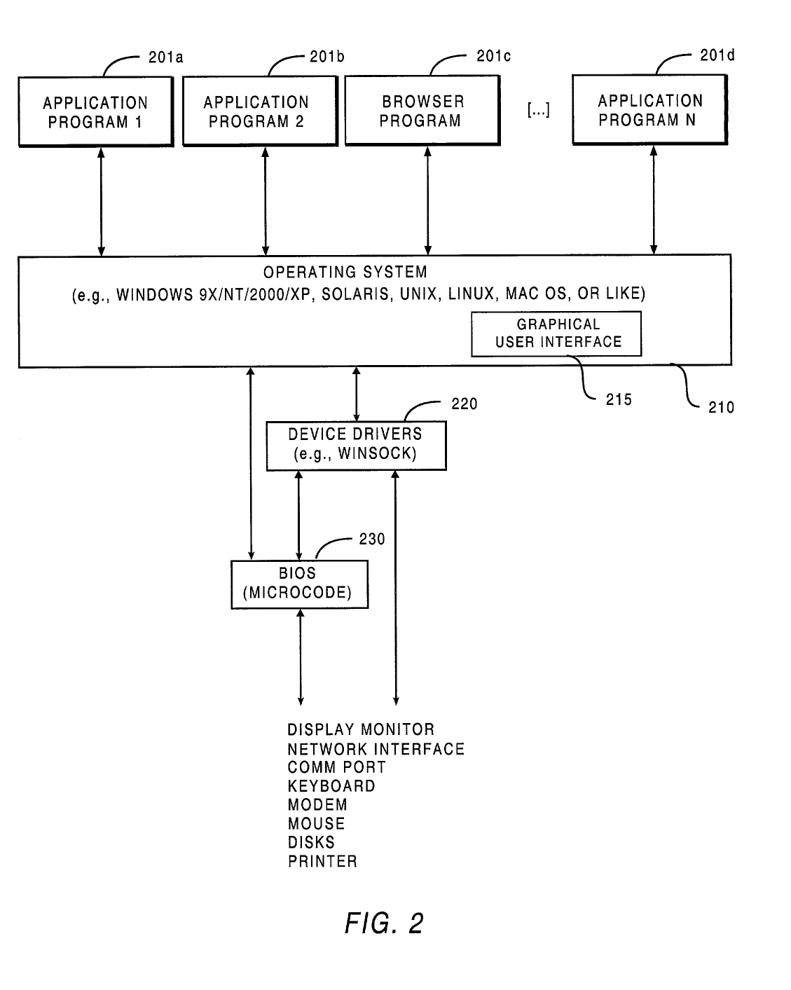

Illustrated in FIG. 2, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100.

System 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft® Windows 9x, Microsoft® Windows NT, Microsoft® Windows 2000, or Microsoft® Windows XP, all available from Microsoft Corporation of Redmond, Wash. Alternatively, OS 210 can also be an alternative operating system, such as the previously-mentioned operating systems.

The above-described computer hardware and software are presented for purposes of illustrating the basic underlying desktop and server computer components that may be employed for implementing the present invention. For purposes of discussion, the following description will present examples in which it will be assumed that there exists a “server” (e.g., URL-addressable network server) that communicates with one or more “clients” (e.g., end-user operated computing devices). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

II. Multi-Party Collaboration Across a Data Network

A. Overview

Currently, users can proactively view objects of interest at a URL-addressable network site. What is desired is an automatic system that notifies the users, or collaborators, whenever it is interesting to review the state of those objects, that is, whenever the state of those objects has changed. For example, with a photo-sharing URL-addressable network site it is desirable to include a two-way messaging system, or to provide functionality behaving like a two-way messaging system, to facilitate collaboration amongst users. In this situation, each user uses a link (e.g., URL) from one of the incoming messages to navigate to an online album to view the photos of interest, to review prior comments about the photos, and to post a new comment along with the others. In this manner, the user collaborates in the online sharing of commentary about objects of common interest. Subsequently, other users are automatically notified of the addition of a user's (collaborator's) newest comments, and they can use a corresponding notification link that accompanies the notification message to access that collaborator's newest comments. After seeing the newest comments, other users may leave further comments. The system of the present invention in turn sends notification to all other clients in the collaborative group so that other collaborators may continue to reply. These replies add additional comments for others to read if they decide to do so. This collaborative cycle may continue to repeat, as desired.

The system of the present invention incorporates dynamic URL-based collaborative document access, a chat-style interface for update notifications, and open-standard messaging channels such that it can be implemented with open standards client systems. The preferred embodiment is a system wherein all the digital photos and comments at a photo-sharing URL-addressable network site reside in a single centralized repository, and the messages that are dispatched are links to both the photo images and the currently updated collection of comments. A message (e.g., XML message) describing the interface at the photo-sharing URL-addressable network site is optionally provided (i.e., a message describing the interface for providing comments). The message may also include access to a running history, or list, of all prior related comments available.

Although all the items related to a group of photos or album(s) are available through a message describing the interface at the photo-sharing URL-addressable network site, the interaction and the experience for the users more resembles instant messaging or “chat.” In typical chat-style messaging, one user leaves a comment, then someone else leaves a different comment, then the first user leaves another comment, then yet another user leaves yet another comment, and so on. Typically, conventional chat messaging requires the users to proactively send, or dispatch, the messages to the targeted recipient(s). Such conventional chat systems also tend to be “chatty”—that is, generating excessive message traffic, sometimes to the point of annoying many of the participants.

By adopting URL-based document(s), the approach of the present invention allows URL-addressable network-based access to the objects of interest (e.g., the digital images and the posted comments), and access to the notification/messaging exchange allowing users to indirectly respond back-and-forth in an open forum. The interaction is formalized as a chat model that allows the back-and-forth responses among only those users who want to actively pursue the notification links, and to possibly contribute further responses.

Prior systems permitted users to view the state of the URL-addressable network site, that is, to return to the site to see the images/comments once, and allowed the owner to respond by possibly modifying the objects (e.g., the photo albums). The approach of the present invention, in contrast, is to provide for a “chat” type of interaction. Notifications are automatically dispatched by the service, rather than manually by the collaborating clients. Notification of any change to the objects is dispatched only once to each client following each time (if any) that such client last participated in the collaborative process by accessing the particular URL-addressable network site share account (i.e., requesting the message describing the collaborative interface). In other words, notification is only provided to users that responded to a prior notification by traversing the URL link included with the message and opening the collaborative (commenting) interface.

With the integration of an open-standards URL-based document store and an open-standards asynchronous messaging mechanism, the system of the present invention can dispatch the notification via any commonly available asynchronous messaging system. The message “body” contains both text-based referencing URLs and text-based messages, which are supported by all commonly available asynchronous messaging systems. When the client, or user, performs actions on the URL, that client is always returned to the appropriate message describing the collaborating interface at the URL-addressable network site.

With asynchronous messaging, the messages can be “pushed” (at any time), as opposed to more synchronous-like messaging where messages are specifically “requested” by the user. The approach of the present invention is also extensible to transport media that may not be strictly asynchronous, such as a program on the client computer that polls for new mail on a POP3 e-mail server at regular intervals without any prompting from the user. These types of messaging systems appear asynchronous to the user, because new messages suddenly appear; these messages are pushed, however, not requested (or “pulled” by the recipient). The client is not required to be available at the time when a message is pushed to it, because a third-party mail server, acting as a middleman, is available to receive messages pushed in real-time.

B. System Architecture

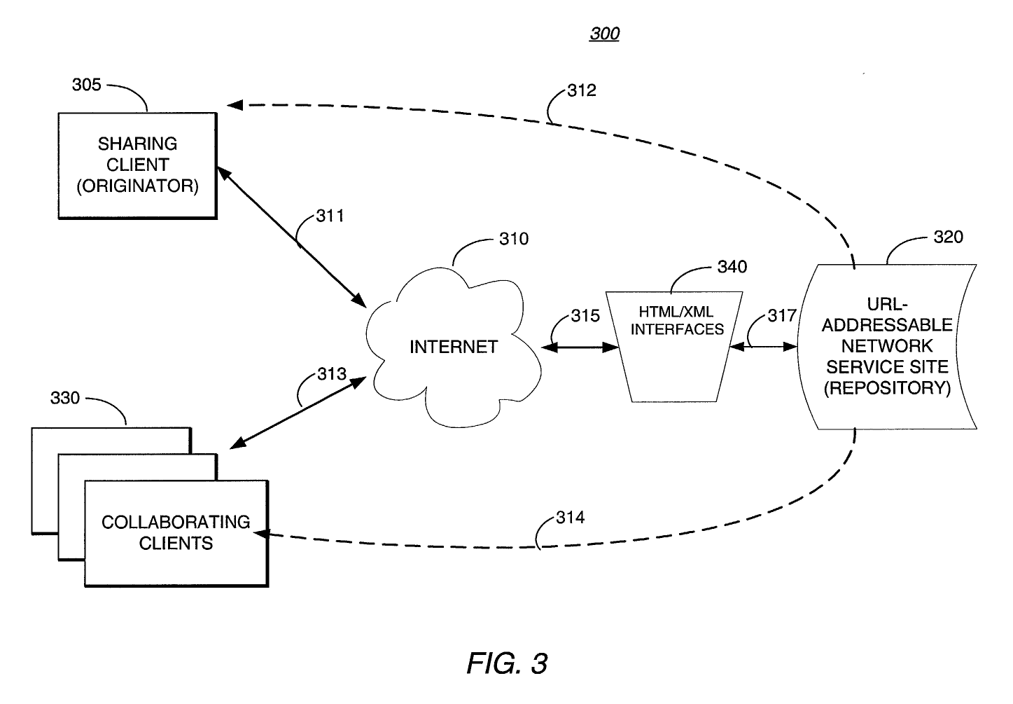

FIG. 3 is a high-level block diagram illustrating the major components of a collaborative messaging system 300 constructed in accordance with the present invention. FIG. 3 includes a sharing client 305 which is the originator/owner of the objects (e.g., digital images or documents), the Internet 310, a URL-addressable network service site (repository) 320 for the shared objects, other collaborating clients 330 who are participants in the collaborative exchange, and a message describing the collaborating interface 340 through which the clients 305 and 330 interact with the repository 320.

For communication, two separate channels are employed: synchronous communication channels 311, 313, 315, 317 and asynchronous communication channels 312, 314. The synchronous communication channels 311, 313, 315, 317 are illustrated with solid lines representing synchronous communication using URL-addressable network communication protocols, such as the Hyper-Text Transport Protocol (HTTP), the Wireless Session Protocol (WSP), the File Transport Protocol (FTP), the Internet Message Access Protocol (IMAP), or the like. The asynchronous communication channels 312, 314 are illustrated with dashed lines representing communication using any asynchronous messaging protocol.

The URL-addressable network (synchronous) protocols are in the form of paired request-response communication. The asynchronous messaging protocols, in contrast, push messages without any notion of a request or a response to a request. The synchronous URL-addressable network protocols are of interest largely because they support a URL-addressable network. The asynchronous messaging protocols are used to send simple text: a URL text string accompanying a brief notification message, which is also text. Unsolicited, the asynchronous messages are “pushed” to the clients, such as e-mail messages arriving in a user's e-mail “inbox.” Alternatively, if the client device is a URL-addressable network-enabled device, such as a cellular phone, the asynchronous messages appear on the device whenever another message is sent to the device.

The sharing client 305 is a URL-addressable network client that uploads one or more documents or objects of interest (“objects”), across the Internet 310, to his or her share account at a URL-addressable network service site 320 (referred to herein as repository 320), which stores these objects in a local repository. This upload uses a synchronous request-response communication protocol, with the sharing client 305 uploading the original objects, and the repository 320 returning an acknowledgement of the success/failure of both the uploading and the storing operations. The repository 320 returns, via one or more asynchronous messaging protocols, a URL address for each stored object to the sharing client 305. The sharing client 305 can use the URL to access both the online object and an associated message describing the sharing interface 340 via the Internet 310. The message describing the sharing interface 340 includes a link (e.g., URL) to the object and an HTML or XML message describing for the sharing client 305 how to input the e-mail addresses of collaborating clients 330 with whom the sharing client 305 wishes to share the uploaded objects.

After the sharing client 305 has input these e-mail addresses, the repository 320 sends a message including the URL of the object(s), via any asynchronous messaging protocol, to the collaborating clients 330 who are participants in the collaborative exchange and to the sharing client 305. This message also includes a URL address for a message describing the collaborating interface 340. The collaborating clients 330 can use this URL to access an address where they can download the message describing the collaborating interface 340 with which to share access to the objects and modifications and comments (collectively “updates”) from the other collaborating clients 330. The message describing the collaborating interface 340 is serviced across the URL-addressable network by the repository 320. The collaborating clients 330, as well as the sharing client 305, can use the message describing the collaborating interface 340 to upload, via the synchronous URL-addressable network protocol, their updates to the repository 320. The repository 320 stores each uploaded update, determines the URL for the stored update, and sends asynchronous messages including the URL to the collaborating clients 330 (and to the originating client 305), notifying them of the new updates contributed to the objects. The sharing client 305 is also considered a member of the group of collaborating clients 330 and receives the same notifications as provided to the collaborating clients 330.

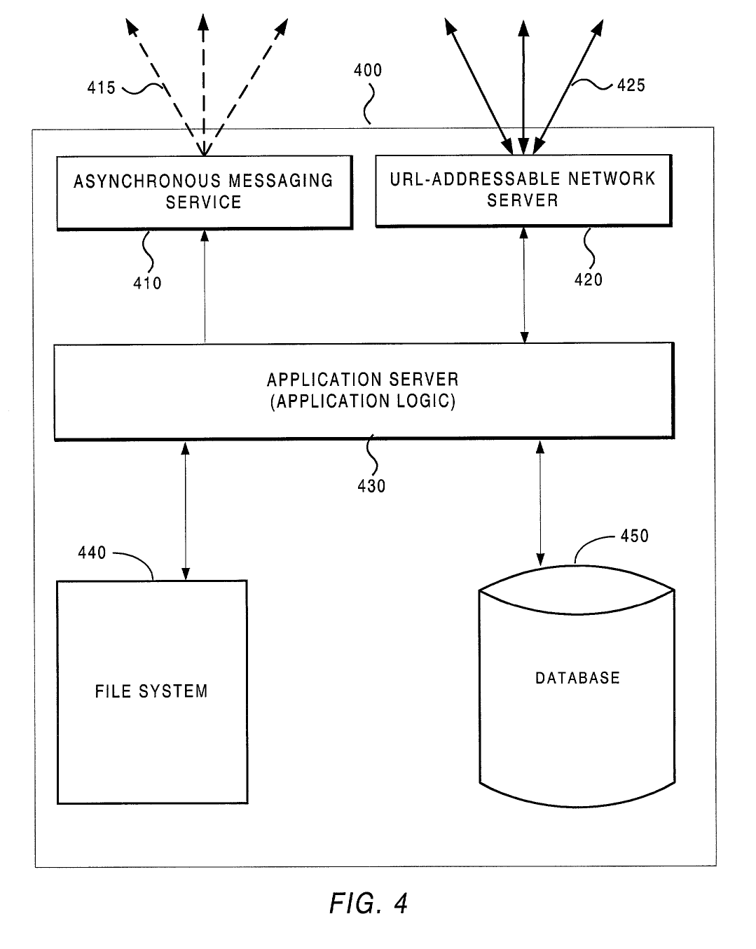

FIG. 4 is a lower-level block diagram of the components comprising the repository 320 shown in FIG. 3. FIG. 4 illustrates the URL-addressable network service site (repository) 400, which includes an asynchronous messaging service 410, which is a server-side client process, an asynchronous messaging channel 415, a URL-addressable network server 420, a synchronous paired request-response communication channel 425, an application server 430 (including Java servlets, Apache plug-ins, and/or Common Gateway Interfaces or CGI), a file system 440, and a database 450.

Incoming requests over the synchronous communication channel 425 to the URL-addressable network server 420 represent the uploading of objects (e.g., images or documents) from the originating sharing client, uploading of updates from the collaborating clients, or downloading of any of these URL-addressable documents (which, in the case of the preferred embodiment, are either digital images or comments about the images). The URL-addressable network server 420 passes these requests to the application server 430, which communicates with both the file system 440 and the database 450. The file system 440 is usually either an NFS (UNIX) or SMB (Microsoft Windows) file system. The database 450 is typically an SQL database. The file system 440 stores the objects (e.g., images or documents) as large binary data (BLOBs), and the database 450 stores metadata about the shared objects and the clients. The metadata includes the clients' updates, the ID of the owner of the original object (i.e., the sharing client), the notification addresses, and the objects' access logs (per addressee) associated with their addresses. The application server 430 manages all the service operations, and instructs the asynchronous messaging service client 410 when, and to whom, to send asynchronous notification corresponding to newly posted updates from the collaborating clients.

The URL-addressable network server 420 uses the HTTP or FTP or WSP or IMAP synchronous communication protocols. The asynchronous messaging service 410 can use any one of many messaging networks like SMTP (Internet e-mail), SMS (the GSM messaging system), WAP-push (an asynchronous WAP protocol), or any of the many instant messaging protocols (e.g., AOL's Instant Messenger, MSN Messenger, or Yahoo Messenger). Alternatively, however, the present invention could be implemented to operate both the asynchronous and synchronous communication channels via the IMAP (e-mail) protocol, but this alternative would require the networked clients to install the IMAP network client software on their devices.

In the currently preferred embodiment, the following exemplary Java code module illustrates the metadata about the shared objects(s) and the collaborating clients, how objects are stored in the system, and how notifications are made to the group of collaborating clients.

```
/**
  * inserts records to the Share_t & share_invite_T tables and returns
shareid.
  *
```

| | |
|---|---|
| * @param name | userid, |
| * | toShare - a URL object and |
| * | inviteAddresses - list of Internet Addresses |
| * | |
| * @return | shareId. |

```
  *
  * @exception SharingServiceException if not inserted.
  */
  // should build the correct objects and then call the other
shareResource //
  public long shareResource(long userid,
```

String retailer,
String shareName,
String toShare,
javax.mail.internet.InternetAddress

fromAddress,

javax.mail.internet.InternetAddress[ ]

inviteAddresses,

String messageSubject,
String messageBody,
boolean commentEmailSentFlag) throws

SharingServiceException

{
HashBackedShare share = new HashBackedShare( );
HashBackedInvite[ ]invites = new HashBackedInvite [inviteAddresses.length];

long shareid = NULL_ID;

try {

for (int i = 0; i < inviteAddresses.length; i++) {

invites[i] = new HashBackedInvite( );
if (inviteAddresses[i].getPersonal( ) != null) {

invites[i].setEmailAddress(inviteAddresses[i]);

invites[i].setPersonalName(inviteAddresses[i].getPersona
l( ));

}
else {

invites[i].setEmailAddress(inviteAddresses[i]);

}

}

share.setRetailer(retailer);

share.setShareName(shareName);
share.setSharedResource(toShare);
share.setCommentEmailSent(commentEmailSentFlag);
share.setFromEmailAddress(fromAddress);
shareid = shareResource( userid, share, invites);
share.setShareID(shareid);
sendInstantMessage( userid, share, messageSubject);
sendMail(userid, share, messageSubject, messageBody);

}
catch (Exception nest) {

Log.printError(className,NOSHARE, “Could not share resource: ‘“

+ nest.getMessage( ) + ”’”);

throw new SharingServiceException( “could not share

resources.”, nest);

}
return shareid;

}

//and here's sendInstantMessage -->//

private void sendInstantMessage(long userid, Share share, String

messageSubject) throws SharingServiceException {

Invite[ ] invites = selectInvites(userid, share.getShareID( ), 0,

SharingService.SORT_INVITES_BY_EMAIL_ADDRESS,
SharingService.SORT_INVITES_BY_EMAIL_ADDRESS);

if (invites == null ∥ invites.length == 0) {

return;

}
try {

String[ ] userProfileInformation =

AuthServices.getUserProfile(userid);

String login = userProfileInformation

[AuthServices.PROFILE_FIRST_NAME];

String password = userProfileInformation

[AuthServices.PROFILE_LAST_NAME];

for (int i=0; i < invites.length; i++) {

if (invites[i].getEmailAddress( ).getAddress( ).indexOf(‘@’) ==
−1) {

// This is not an ordinary email address so we will just send an instant

message.//

StringBuffer messageBody = new StringBuffer( );
messageBody.append(“ has invited you to a <a href=\“http://”);
messageBody.append(Config.getProperty(“SHARING_RETURN_HOST”)).app
end(“/guest/guest_share2.jsp?invite=”);

messageBody.append(invites[i].getInviteIdToken( ));
messageBody.append(“\”>private photo conversation</a> ;−)”);
LogWriter.err.printInfo(“message body: ” +

messageBody.toString( ));
boolean succeeded = false;
// since we're sending udp packets, there is a chance of
failure//
for (int j = 0; j < 10; j++) {

String service = null;
if (invites[i].getEmailAddress( )

.getAddress( ).indexOf(‘%’) != −1) {
service = “msn”;
}
else {

service = “aim”;

}

succeeded = ShareInstantMessage.share( service,
“okra.office.lightsurf.com”, login, password,

invites[i].getEmailAddress( ).getAddress( ), messageSubject,
messageBody.toString( ));
if (succeeded) break;
}

LogWriter.err.printInfo(“Success in sharing to MSN instant messenger:
” + succeeded);
if (!succeeded) {

throw new SharingServiceException(“BAD”);

}

}

```
  }
  }
  catch (Exception e) {
  e.printStackTrace( );
  throw new SharingServiceException(e.getMessage( ));
  }
}
```

C. Detailed Operations

The present invention enables a sharing client to initiate online collaborative review of related URL-addressed objects (e.g., images or documents), and allows the participants to be informed whenever the objects are updated. The preferred embodiment maintains a collaborative chat-like activity corresponding to a sharing account of the sharing client at a sharing URL-addressable network site. The asynchronous messaging service described above sends an asynchronous notification, only once, to each client that new updates have been posted at the sharing URL-addressable network service site since the last time that client visited this network site.

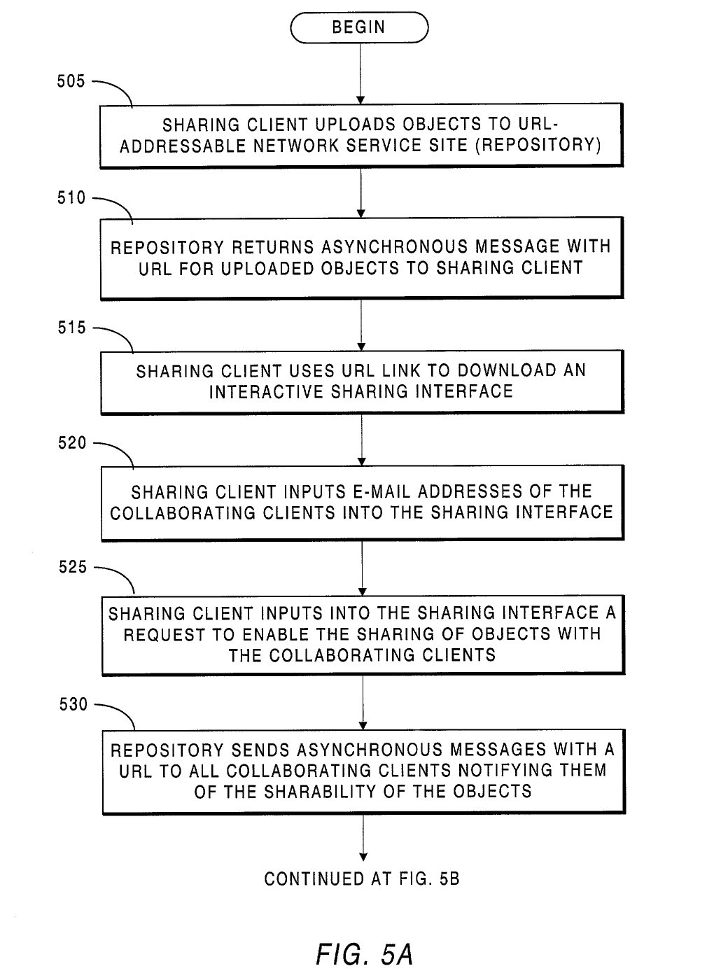

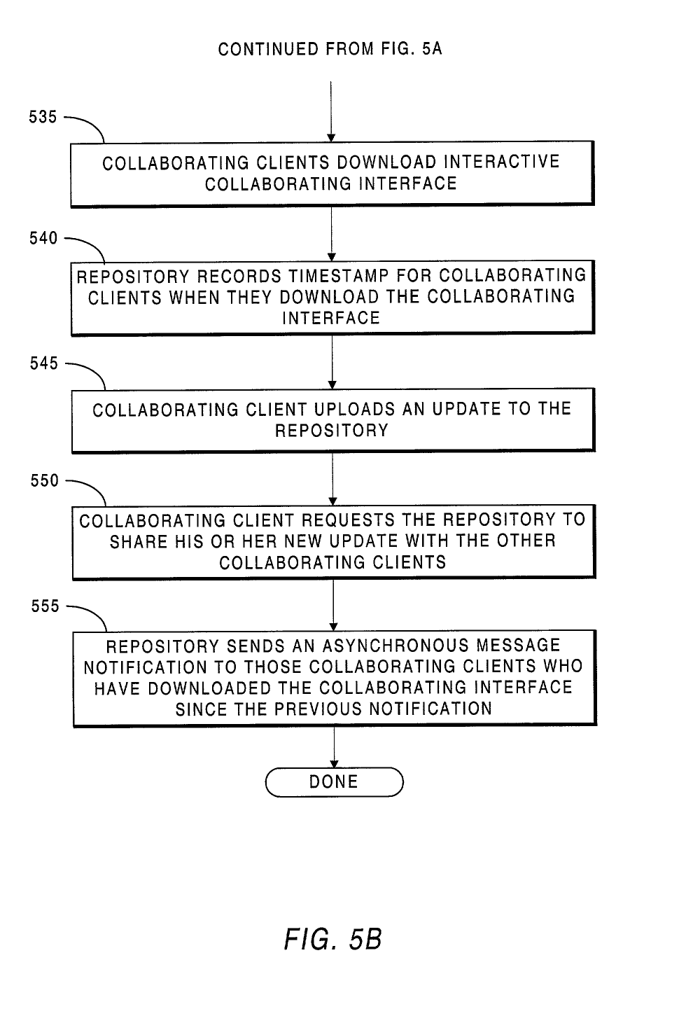

FIGS. 5A and 5B are a two-page flowchart showing the sequence of operations of the present invention. At step 505, the owner, or original sharing client uploads to his or her account at a URL-addressable network sharing service site (referred to herein as repository) one or more objects of interest, which can include text documents and multimedia objects. At step 510, a message is returned to the sharing client via an asynchronous messaging system. The message contains a URL indicating the Internet location of a message describing the interactive sharing interface that corresponds to the uploaded object at the repository. At step 515, the sharing client uses that URL to access a server where it can download the message describing the sharing interface onto either a browser or an e-mail client on the device of the sharing client. The sharing client user requests to download the message describing the sharing interface by performing an action to traverse the URL link in the asynchronous message. Performing the action to traverse the URL link in the message sends a request to the repository to return the message describing the sharing interface to the sharing client's browser (or e-mail client). At step 520, the sharing client fills in the e-mail address fields in the sharing interface form with the e-mail addresses for the multiple collaborating clients. These addresses will receive the asynchronous message notifications of the initial availability of the shared objects and subsequent updates, either to the objects or to related URL-addressable documents, by the collaborating clients. At step 525, the sharing client then requests that the repository share the objects with the collaborating clients at those addresses.

At step 530, the repository sends asynchronous messages to all the collaborating clients. This message contains a URL indicating the location of a message describing the collaborating interface. This message describing the collaborating interface is associated with the corresponding uploaded objects at the repository. The message describing the collaborating interface is used by the collaborating clients to understand how to download the shared objects, to post updates regarding the shared objects (which are also shareable) at the repository, and to download any of the posted updates. The message describing the collaborating interface can also be used by the sharing client to understand how to download any of the posted updates. At step 535, the collaborating client uses the URL to download the message describing the collaborating interface from the server (at the repository) to his or her browser that resides locally. At step 540, the application server at the repository logs in the database the time that each collaborating client first downloads the message describing the collaborating interface. The timestamp for a collaborating client is associated with the message describing the collaborative interface of that object in the repository.

At step 545, the collaborating client makes updates either to the URL-addressed objects or to related documents, that the collaborating client would like to share with the other collaborating clients (and with the sharing client). At step 550, the collaborating client requests that the repository share the modifications with the other collaborating clients (as well as with the sharing client). At step 555, the repository sends an asynchronous change notification message, together with a URL address to the message describing the collaborating interface. This notification is sent to each of the collaborating clients (and to the sharing client) if such clients have downloaded the message describing the collaborating interface since the last time a message was sent. The timestamp recorded at step 540 is used to determine if the client has downloaded the message describing the collaborative interface since his or her previous notification. If the client has downloaded the message since the previous notification, then the asynchronous messaging service at the repository sends a message of notification to the client. This notification message contains a URL indicating the URL address of the message describing the collaborating interface that corresponds to the uploaded objects on the server at the repository. Whenever a client performs an action to traverse the URL link accompanying an asynchronous message notification, that client downloads the message describing the collaborating interface, which includes link(s) to the newest updates.

If the client does not perform an action to traverse the URL link, the client is not notified of subsequent updates as they are posted to the URL-addressable network sharing service site. However, whenever the client subsequently performs an action to traverse the URL link, the message describing the collaborating interface he or she downloads includes all of the updates, which include the newer updates. If the last asynchronous message notification to a client is more recent than the timestamp (in the database) recorded when the client last downloaded the message describing the collaborating interface, then the repository does not continue to send notifications of newer updates. The procedure then continues again from step 535, until the sharing client requests the repository to discontinue the collaborative process.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A method for multi-party network collaboration, the method comprising:
enabling an initial sharing client to upload objects and network addresses of collaborating clients to a URL-addressable network service site;
storing said objects in a repository at said URL-addressable network service site;
tracking the status of said objects in said repository;
automatically providing notification to said collaborating clients of the availability of objects or any updates to said objects using asynchronous messaging protocols; and
enabling collaborating clients to upload and download objects and modifications, comments and other updates to said objects using synchronous messaging protocols.

2. The method of claim 1, wherein said network includes the Internet.

3. The method of claim 1, wherein said objects include documents.

4. The method of claim 1, wherein said objects include digital images.

5. The method of claim 1, wherein said objects include modifications, comments and other updates to said objects.

6. The method of claim 1, wherein said collaborating clients include said initial sharing client.

7. The method of claim 1, wherein said asynchronous messaging is extensible to synchronous client communications delivery systems that simulate asynchronous messaging.

8. The method of claim 1, wherein said collaboration includes sharing digital images serviced by a photo-sharing network site.

9. The method of claim 8, wherein said collaboration includes adding comments about said shared digital images.

10. The method of claim 1, wherein said enabling collaborating clients to upload and download modifications, comments and other updates includes providing HTML or XML messages describing interfaces for input of modifications, comments and other updates.

11. The method of claim 1, wherein said notification includes providing Universal Resource Locators (URLs) to said HTML or XML messages describing interfaces.

12. The method of claim 11, wherein said collaborating clients may respond to said notifications using said URLs.

13. The method of claim 1, wherein said URL-addressable network site and said collaborating clients communicate with bi-directional request-response communication protocols.

14. The method of claim 13, wherein said bi-directional request-response communication protocols include the Hyper Text Transfer Protocol (HTTP).

15. The method of claim 13, wherein said bi-directional request-response communication protocols include the Wireless Session Protocol (WSP).

16. The method of claim 13, wherein said bi-directional request-response communication protocols include the File Transfer Protocol (FTP).

17. The method of claim 13, wherein said bi-directional request-response communication protocols include the Internet Message Access Protocol (IMAP).

18. The method of claim 1, wherein said initial sharing client uploads objects using said bi-directional request-response communication protocols.

19. The method of claim 1, wherein said collaborating clients download said objects using said bi-directional request-response communication protocols.

20. The method of claim 1, wherein said collaborating clients upload updates to said objects using said bi-directional request-response communication protocols.

21. The method of claim 1, wherein said network site determines when said notifications are transmitted.

22. The method of claim 1, wherein notifications are provided to some number of the collaborating clients.

23. The method of claim 1, wherein notifications are provided only to collaborating clients who have responded to a prior notification.

24. The method of claim 1, wherein said network site determines those collaborating clients to which said notifications are to be provided by performing the substeps of:
logging a timestamp corresponding to each response by each collaborating client; and
providing notifications only to those collaborating clients that have responded subsequent to the most recent prior notification.

25. The method of claim 24, wherein all updates are made available to collaborating clients responding to any notification, including updates made after the provision of said notification.

26. The method of claim 1, wherein HTML or XML messages describing interfaces are provided to said initial sharing client for upload of said objects and said addresses of collaborating clients.

27. The method of claim 26, wherein said initial sharing client downloads said messages describing interfaces from said network service site.

28. A system for multi-party online network collaboration, the system comprising:
a synchronous communication channel for uploading and downloading objects, information regarding collaborating clients, and updates to objects to, or from, a URL-addressable network server;
an application server tracking the objects, tracking said collaborating clients' interaction with said objects and automatically initiating notifications to said collaborating clients upon uploading of objects or updates thereto;
a repository for storing objects, updates thereto and information regarding said objects, updates and collaborating clients; and
an asynchronous messaging service for transmitting notifications to said collaborating clients using asynchronous messaging channels.

29. The system of claim 28, wherein said network includes the Internet.

30. The system of claim 28, wherein said objects include documents.

31. The system of claim 28, wherein said objects include digital images.

32. The system of claim 28, wherein said objects include related comments regarding said objects.

33. The system of claim 28, wherein said collaborating clients include said initial sharing client.

34. The system of claim 28, wherein said asynchronous messaging channel includes synchronous client communications delivery systems that simulate asynchronous messaging.

35. The system of claim 28, wherein said updates include comments about said objects.

36. The system of claim 28, further comprising:
HTML or XML messages describing interfaces for input of comments or updates.

37. The system of claim 36, wherein said messages describing interfaces are stored in said repository and are accessible to said collaborating clients.

38. The system of claim 37, wherein said notification to collaborating clients includes providing URLs to said messages describing interfaces.

39. The system of claim 37, wherein said collaborating clients may access objects and updates in said repository using said URLs.

40. The system of claim 28, wherein said application server determines when said notifications are dispatched.

41. The system of claim 28, wherein said application server determines to which collaborating clients to send said notifications.

42. The system of claim 28, wherein notifications are transmitted to some number of the collaborating clients.

43. The system of claim 28, wherein notifications are transmitted only to collaborating clients who have responded to a previously transmitted notification.

44. The system of claim 28, wherein said application server determines those collaborating clients to which said notifications are to be transmitted by performing the substeps of:
logging a timestamp corresponding to each response by each collaborating client; and
transmitting notifications only to those collaborating clients that have responded subsequent to the most recently transmitted notification.

45. The system of claim 28, wherein all updates are made available to collaborating clients responding to any notification, including updates made after the transmission of said notification.

46. The system of claim 28, further comprising:
HTML or XML messages describing interfaces for upload of said objects

47. The system of claim 46, wherein said messages describing interfaces are downloaded from said URL-addressable network server.

48. The system of claim 28, further comprising:
HTML or XML messages describing interfaces for upload of said objects and said addresses of collaborating clients.

49. The system of claim 48, wherein said initial sharing client downloads said messages describing interfaces from said URL-addressable network server.

50. The system of claim 28, wherein said synchronous communication channels include channels using the Hyper Text Transfer Protocol (HTTP).

51. The system of claim 28, wherein said synchronous communication channels include channels using the Wireless Session Protocol (WSP).

52. The system of claim 28, wherein said synchronous communication channels include channels using the File Transfer Protocol (FTP).

53. The system of claim 28, wherein said synchronous communication channels include channels using the Internet Message Access Protocol (IMAP).

54. The system of claim 28, wherein said repository includes a file system.

55. The system of claim 28, wherein said repository includes a database.

56. The system of claim 28, wherein said asynchronous messaging channels include channels using the Simple Mail Transfer Protocol (SMTP).

57. The system of claim 28, wherein said asynchronous messaging channels include channels using the Short Message Service (SMS).

58. The system of claim 28, wherein said asynchronous messaging channels include channels using the WAP-push protocol.

59. The system of claim 28, wherein said asynchronous messaging channels include many common “instant messaging” protocols.

60. In an online system, a method for automating asynchronous messaging, the method comprising:
tracking the transmission of information to said online system by collaborating clients;
automatically issuing asynchronous messages to collaborating clients when information is received by said online system; and
restricting transmission of asynchronous messages to only those collaborating clients who have responded to a previously transmitted message.

61. The method of claim 60, wherein said collaborating clients are networked clients to said online system.

62. The method of claim 60, wherein said online system includes a network service site.

63. The method of claim 60, where HTML or XML messages describing interfaces are provided to said collaborating clients for input of information into said online system.

64. The method of claim 60, wherein a URL to said network service site is provided with said asynchronous messages.

65. The method of claim 60, wherein said URL enables download of said HTML or XML messages describing interfaces.

66. The method of claim 65, wherein said network service site determines which collaborating clients are to be issued messages by performing the substeps of:
logging a timestamp corresponding to each download of said interfaces by each collaborating client; and
transmitting asynchronous messages only to collaborating clients that have downloaded one or more of said interfaces subsequent to the previous transmitted message.
